(19) United States
(12) Patent Application Publication
(10) Pub. No.: US 2016/0239186 A1
(43) Pub. Date: Aug. 18, 2016

(54) SYSTEMS AND METHODS FOR AUTOMATED GENERATION OF GRAPHICAL USER INTERFACES

(71) Applicant: Limited Liability Company Mail.Ru, Moscow (RU)

(72) Inventor: Pavel Skripkin, Fryazino (RU)

(21) Appl. No.: 14/997,947

(22) Filed: Jan. 18, 2016

Related U.S. Application Data
(63) Continuation of application No. PCT/RU2013/000621, filed on Jul. 19, 2013.

(51) Int. Cl. G06F 3/0484; G06T 3/40; G06F 3/0481; G06T 11/60; G06F 3/0488; G06T 5/00; G06T 11/00

(52) U.S. Cl. CPC G06F 3/04845; G06T 5/002; G06T 3/40; G06T 11/00; G06T 11/60; G06F 3/04883; G06F 3/0481; G06T 2200/24

(57) ABSTRACT

A computer-implemented method for automated generation of a graphical user interface for a target application, the method being performed in connection with a computerized system comprising a processor, a memory and a display device, the method involving: obtaining a content associated with the target application; using the obtained content to generate a central graphical element, the central graphical element being generated using at least a first portion of the obtained content; magnifying at least a second portion of the content; applying a Gaussian blurring filter to the magnified second portion of the content; generating a background image based on the blurred magnified second portion of the content; and generating the graphical user interface, the graphical user interface comprising the central graphical element, the background image and a content block, wherein the central graphical element and the content block overlay the background image.

### BACKGROUND OF THE INVENTION

1. Technical Field

The disclosed embodiments relate in general to user interfaces of electronic computing devices and, more specifically, to systems and methods for automatically generating graphical user interfaces.

2. Description of the Related Art

In designing of graphical user interfaces for various computing devices, a need often arises to automatically generate a graphics-enhanced front or title page or screen for a collection of content, a profile, such as a user profile or a software application. It is desirable for the generated graphical page or screen to contain some type of visual indication of the information contained in the content collection or the profile or the nature of the associated software application. In addition, the generated page should distinguish the associated content or profile from similar content or profiles and also be visually appealing to users.

On the other hand, it is also desirable to keep the same or substantially the same positional arrangement of various graphical elements, control elements of the graphical user interface and/or informational items in the generated page or screen.

However, the conventional technology fails to provide graphical user interface generation techniques that satisfy the above requirements. Therefore, new and improved techniques for automatically generating graphical title page for a collection of content or a profile, such as user profile, or a software application are needed.

### SUMMARY OF THE INVENTION

The embodiments described herein are directed to methods and systems that substantially obviate one or more of the above and other problems associated with conventional techniques for generating graphical user interfaces.

In accordance with one aspect of the inventive concepts described herein, there is provided a computer-implemented method for automated generation of a graphical user interface for a target application, the method being performed in connection with a computerized system comprising a processor, a memory and a display device. The method involves: obtaining a content associated with the target application; using the obtained content to generate a central graphical element, the central graphical element being generated using at least a first portion of the obtained content; magnifying at least a second portion of the content; applying a Gaussian blurring filter to the magnified second portion of the content; generating a background image based on the blurred magnified second portion of the content; and generating the graphical user interface, the graphical user interface comprising the central graphical element, the background image and a content block, wherein the central graphical element and the content block overlay the background image.

In one or more embodiments, the content block comprises at least one interactive graphical user interface control element.

In one or more embodiments, the content block comprises textual content descriptive of the target application.

In one or more embodiments, the target application is a software application.

In one or more embodiments, the target application is a user profile.

In one or more embodiments, the central graphical element has a square shape.

In one or more embodiments, the size of the central graphical element is substantially one-third of the width of the generated graphical user interface.

In one or more embodiments, the central graphical element is horizontally positioned substantially in the middle if the generated graphical user interface.

In one or more embodiments, the content block is positioned substantially below the central graphical element.

In one or more embodiments, the determined length of the user gesture is either a full display width or half display width.

In accordance with another aspect of the inventive concepts described herein, there is provided a non-transitory computer-readable medium embodying a set of computer-readable instructions, which, when executed in connection with a computerized system comprising a processor, a memory and a display device, cause the computerized system to perform a method for automated generation of a graphical user interface for a target application. The method involves: obtaining a content associated with the target application; using the obtained content to generate a central graphical element, the central graphical element being generated using at least a first potion of the obtained content; magnifying at least a second portion of the content; applying a Gaussian blurring filter to the magnified second portion of the content; generating a background image based on the blurred magnified second portion of the content; and generating the graphical user interface, the graphical user interface comprising the central graphical element, the background image and a content block, wherein the central graphical element and the content block overlay the background image.

In one or more embodiments, the content block comprises at least one interactive graphical user interface control element.

In one or more embodiments, the content block comprises textual content descriptive of the target application.

In one or more embodiments, the target application is a software application.

In one or more embodiments, the target application is a user profile.

In one or more embodiments, the central graphical element has a square shape.

In one or more embodiments, the size of the central graphical element is substantially one-third of the width of the generated graphical user interface.

In one or more embodiments, the central graphical element is horizontally positioned substantially in the middle if the generated graphical user interface.

In one or more embodiments, the content block is positioned substantially below the central graphical element.

In one or more embodiments, the determined length of the user gesture is either a full display width or half display width.

In accordance with yet another aspect of the inventive concepts described herein, there is provided a computerized system comprising a processor, a memory and a display device, the memory storing a set of computer-readable instructions, which, when executed by the processor cause the computerized system to perform a method for automated generation of a graphical user interface for a target application. The method involves: obtaining a content associated with the target application; using the obtained content to generate a central graphical element, the central graphical element being generated using at least a first portion of the obtained content; magnifying at least a second portion of the content; applying a Gaussian blurring filter to the magnified second portion of the content; generating a background image based on the blurred magnified second portion of the content; and generating the graphical user interface, the graphical user interface comprising the central graphical element, the background image and a content block, wherein the central graphical element and the content block overlay the background image.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIGS. 1a and 1b illustrate two exemplary embodiments of the graphical user interface generated in accordance with an embodiment of the inventive computer-implemented method.

FIG. 2 illustrates an exemplary embodiment of an operating sequence of the computerized system for automatically generating the graphical user interface.

FIG. 3 is a block diagram that illustrates an embodiment of a computer system upon which an embodiment of the inventive functionality may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there is provided a computerized system and an associated computer-implemented method for automatically generating graphical user interfaces. The term graphical user interface used herein shall be construed in the broadest possible sense and shall include, without limitation, graphical title page or screen for a collection of content or a profile, such as user profile, or a screen of a software application, such as messaging or gaming application. Also, the term application used herein shall cover any type of application or content collection usable on connection with a computing device, including, without limitation, software applications, online applications, web pages, as well as a collections of content and various profiles, such as a user profiles.

In one or more embodiments, the generated graphical user interface comprises a central graphical element in a form of an icon positioned in the middle part of the generated user interface, a text/control block with descriptive content and/or control elements as well as a background image. In one or more embodiments, the aforesaid central graphical element is generated using the content from the content collection or profile or content associated with the software application for which the graphical user interface is being generated. In one or more embodiments, the text/control block may incorporate textual information descriptive of the underlying content, profile or software application. In the same or different embodiment, the text/control block may incorporate one or more control elements of the graphical user interface of the associated software application. Finally, the background image is preferably generated from the same content as the central graphical element using, for example, Gaussian smoothing (blurring) technique well known to persons of ordinary skill in the art.

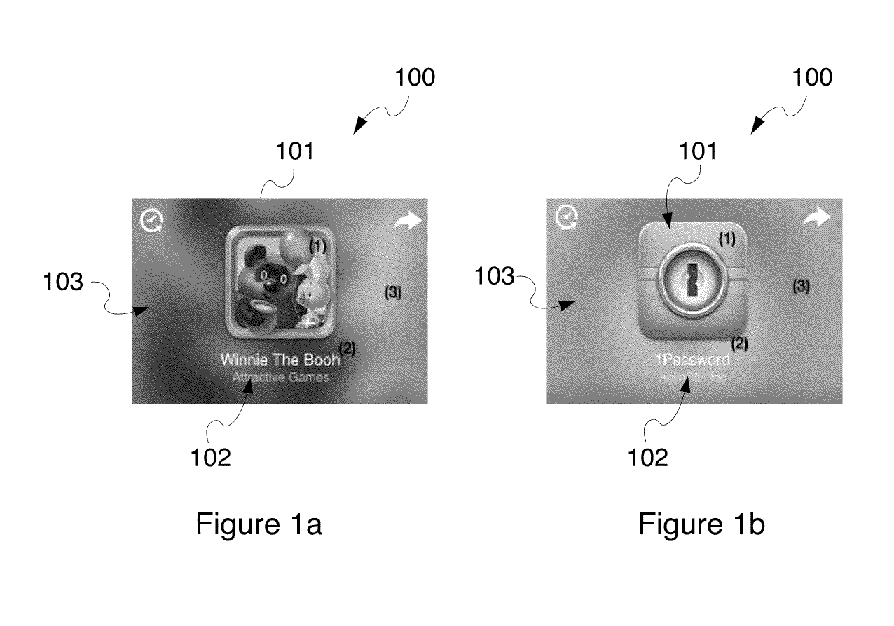

Two exemplary embodiments of the graphical user interface generated in accordance with an embodiment of the inventive computer-implemented method is illustrated in FIGS. 1a and 1b. As shown in FIGS. 1a and 1b, the user interface 100 incorporates a central graphical element 101, a text/control block 102 and a background image 103. The background image 103 may be generated by magnifying the same unit of content as being used in generating the central graphical element 101 and applying a Gaussian filter, well known to persons of ordinary skill in the art, to the resulting magnified image. The text/control box 102, in addition to the textual information of descriptive nature, may incorporate one or more control elements of the graphical user interface of the associated software application, such as a user interface button or a link to additional content. The aforesaid control elements provide interactive functionality to the generated interface allowing the user to retrieve additional content or control the associated software application.

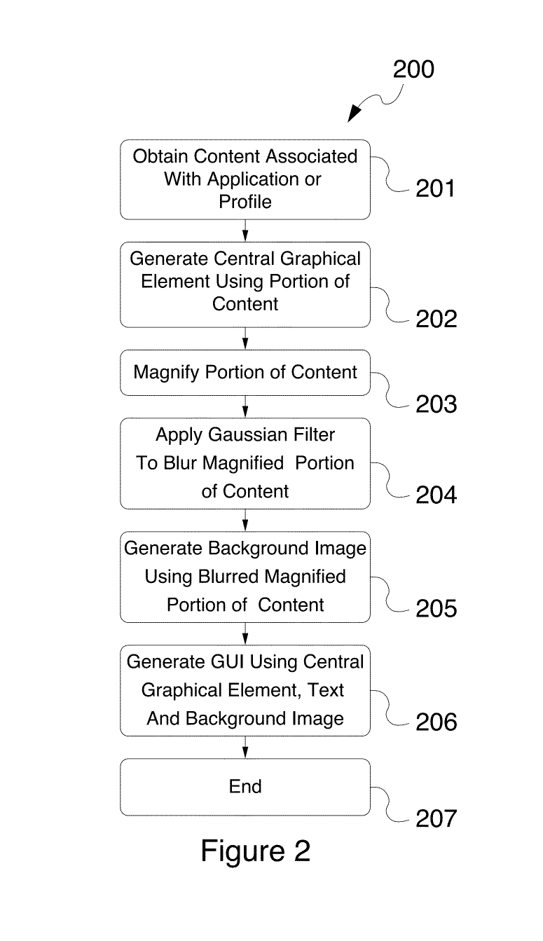

FIG. 2 illustrates an exemplary embodiment of an operating sequence 200 of the computerized system for automatically generating the graphical user interface 100. At step 201, the content associated with the software application or profile is obtained. At step 202, the central graphical element of the graphical user interface is generated using a portion of the obtained content. In one or more embodiments, to generate the central graphical element, the content may be cropped, reduced or magnified, or any combination thereof. In one or more embodiments, the central graphical element may be in a form of an icon or a thumbnail. In one or more embodiments, the central graphical element represents the content associated with the graphical user interface or the nature of the software application. For example, if the software application is a gaming application, the central graphical element may be a portion of a screen from the aforesaid game.

At step 203, a portion of the obtained content is magnified with a predetermined magnification ratio. At step 204, a Gaussian blur filter well known to persons of ordinary skill in the art is applied to the magnified portion of the content. At step 205, the background image for the user interface is generated using the blurred magnified portion of the content. At step 206, the user interface is generated using the central graphical element, the background image and the text/control box, which may contain both textual descriptive content as well as graphical user interface control elements. In one or more embodiments, the aforesaid components of the generated user interface are arranged as illustrated in FIGS. 1a and 1 b. The operation terminates in step 207.

As shown in FIGS. 1a and 1b, in one or more embodiments, the central graphical element 101 may have a square shape. In the same or different embodiment, the central graphical element 101 may have the size of substantially one-third of the width of the graphical user interface 100. In one or more embodiments, the central graphical element 101 may be positioned substantially in the middle of the graphical user interface 100, both horizontally and vertically. In an alternative embodiment, the central graphical element 101 may be positioned centrally horizontally, but vertically displaced towards the top of the graphical user interface 100. In one or more embodiment, the text/control block is positioned substantially below the central graphical element 101. In one or more embodiment, the central graphical element 101 overlays the background image.

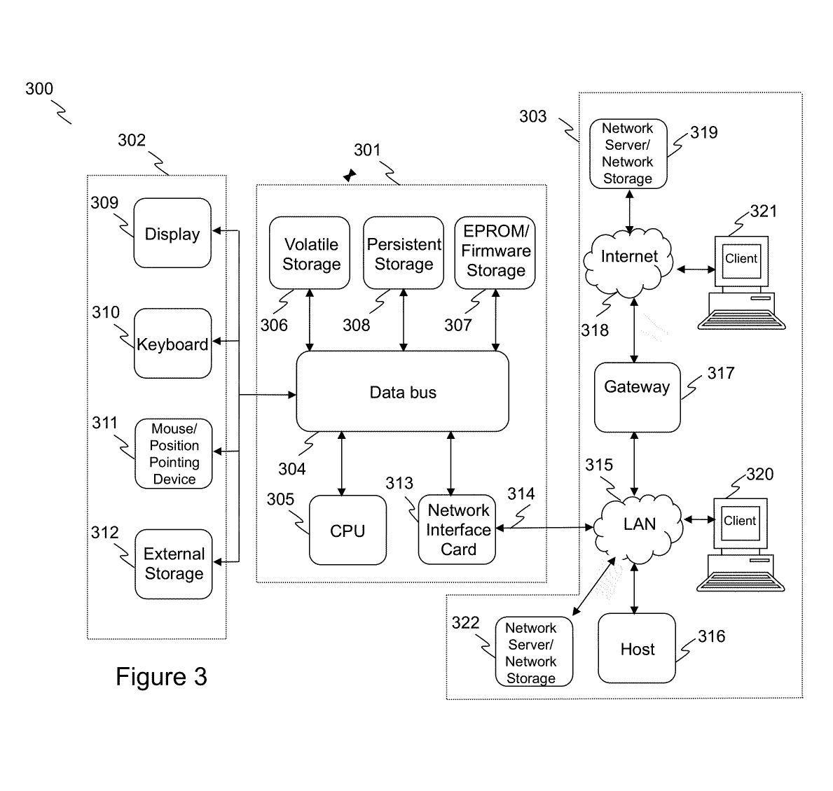

FIG. 3 is a block diagram that illustrates an embodiment of a computer system 300 upon which various embodiments of the inventive concepts described herein may be implemented. The system 300 includes a computer platform 301, peripheral devices 302 and network resources 303.

The computer platform 301 may include a data bus 304 or other communication mechanism for communicating information across and among various parts of the computer platform 301, and a processor 305 coupled with bus 304 for processing information and performing other computational and control tasks. Computer platform 301 also includes a volatile storage 306, such as a random access memory (RAM) or other dynamic storage device, coupled to bus 304 for storing various information as well as instructions to be executed by processor 305, including the software application for automated generation of the graphical user interface described above. The volatile storage 306 also may be used for storing temporary variables or other intermediate information during execution of instructions by processor 305. Computer platform 301 may further include a read only memory (ROM or EPROM) 307 or other static storage device coupled to bus 304 for storing static information and instructions for processor 305, such as basic input-output system (BIOS), as well as various system configuration parameters. A persistent storage device 308, such as a magnetic disk, optical disk, or solid-state flash memory device is provided and coupled to bus 304 for storing information and instructions.

Computer platform 301 may be coupled via bus 304 to a touch-sensitive display 309, such as a cathode ray tube (CRT), plasma display, or a liquid crystal display (LCD), for displaying information to a system administrator or user of the computer platform 301. An input device 310, including alphanumeric and other keys, is coupled to bus 304 for communicating information and command selections to processor 305. Another type of user input device is cursor control device 311, such as a mouse, a trackball, or cursor direction keys for communicating direction information and command selections to processor 305 and for controlling cursor movement on touch-sensitive display 309. This input device typically has two degrees of freedom in two axes, a first axis (e.g., x) and a second axis (e.g., y), that allows the device to specify positions in a plane. To detect user's gestures, the display 309 may incorporate a touchscreen interface configured to detect user's tactile events and send information on the detected events to the processor 305 via the bus 304.

An external storage device 312 may be coupled to the computer platform 301 via bus 304 to provide an extra or removable storage capacity for the computer platform 301. In an embodiment of the computer system 300, the external removable storage device 312 may be used to facilitate exchange of data with other computer systems.

The invention is related to the use of computer system 300 for implementing the techniques described herein. In an embodiment, the inventive system may reside on a machine such as computer platform 301. According to one embodiment of the invention, the techniques described herein are performed by computer system 300 in response to processor 305 executing one or more sequences of one or more instructions contained in the volatile memory 306. Such instructions may be read into volatile memory 306 from another computer-readable medium, such as persistent storage device 308. Execution of the sequences of instructions contained in the volatile memory 306 causes processor 305 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 305 for execution. The computer-readable medium is just one example of a machine-readable medium, which may carry instructions for implementing any of the methods and/or techniques described herein. Such a medium may take many forms, including but not limited to, non-volatile media and volatile media. Non-volatile media includes, for example, optical or magnetic disks, such as the persistent storage device 308. Volatile media includes dynamic memory, such as volatile storage 306.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read.

Various forms of computer readable media may be involved in carrying one or more sequences of one or more instructions to processor 305 for execution. For example, the instructions may initially be carried on a magnetic disk from a remote computer. Alternatively, a remote computer can load the instructions into its dynamic memory and send the instructions over a telephone line using a modem. A modem local to computer system can receive the data on the telephone line and use an infra-red transmitter to convert the data to an infra-red signal. An infra-red detector can receive the data carried in the infra-red signal and appropriate circuitry can place the data on the data bus 304. The bus 304 carries the data to the volatile storage 306, from which processor 305 retrieves and executes the instructions. The instructions received by the volatile memory 306 may optionally be stored on persistent storage device 308 either before or after execution by processor 305. The instructions may also be downloaded into the computer platform 301 via Internet using a variety of network data communication protocols well known in the art.

The computer platform 301 also includes a communication interface, such as network interface card 313 coupled to the data bus 304. Communication interface 313 provides a two-way data communication coupling to a network link 314 that is coupled to a local network 315. For example, communication interface 313 may be an integrated services digital network (ISDN) card or a modem to provide a data communication connection to a corresponding type of telephone line. As another example, communication interface 313 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 313 sends and receives electrical, electromagnetic or optical signals that carry digital data streams representing various types of information.

Network link 314 typically provides data communication through one or more networks to other network resources. For example, network link 314 may provide a connection through local network 315 to a host computer 316, or a network storage/server 322. Additionally or alternatively, the network link 314 may connect through gateway/firewall 317 to the wide-area or global network 318, such as an Internet. Thus, the computer platform 301 can access network resources located anywhere on the Internet 318, such as a remote network storage/server 319. On the other hand, the computer platform 301 may also be accessed by clients located anywhere on the local area network 315 and/or the Internet 318. The network clients 320 and 321 may themselves be implemented based on the computer platform similar to the platform 301.

Local network 315 and the Internet 318 both use electrical, electromagnetic or optical signals that carry digital data streams. The signals through the various networks and the signals on network link 314 and through communication interface 313, which carry the digital data to and from computer platform 301, are exemplary forms of carrier waves transporting the information.

Computer platform 301 can send messages and receive data, including program code, through the variety of network(s) including Internet 318 and LAN 315, network link 315 and communication interface 313. In the Internet example, when the system 301 acts as a network server, it might transmit a requested code or data for an application program running on client(s) 320 and/or 321 through the Internet 318, gateway/firewall 317, local area network 315 and communication interface 313. Similarly, it may receive code from other network resources.

The received code may be executed by processor 305 as it is received, and/or stored in persistent or volatile storage devices 308 and 306, respectively, or other non-volatile storage for later execution.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the systems and methods for automated generation of the graphical user interface. It is intended that the specification and examples be considered as exemplary only, with a true scope and spirit of the invention being indicated by the following claims.

What is claimed is:

1. A computer-implemented method for automated generation of a graphical user interface for a target application, the method being performed in connection with a computerized system comprising a processor, a memory and a display device, the method comprising:
a. obtaining a content associated with the target application;
b. using the obtained content to generate a central graphical element, the central graphical element being generated using at least a first potion of the obtained content;
c. magnifying at least a second portion of the content;
d. applying a Gaussian blurring filter to the magnified second portion of the content;
e. generating a background image based on the blurred magnified second portion of the content; and
f. generating the graphical user interface, the graphical user interface comprising the central graphical element, the background image and a content block, wherein the central graphical element and the content block overlay the background image.

2. The computer-implemented method of claim 1, wherein the content block comprises at least one interactive graphical user interface control element.

3. The computer-implemented method of claim 1, wherein the content block comprises textual content descriptive of the target application.

4. The computer-implemented method of claim 1, wherein the target application is a software application.

5. The computer-implemented method of claim 1, wherein the target application is a user profile.

6. The computer-implemented method of claim 1, wherein the central graphical element has a square shape.

7. The computer-implemented method of claim 6, wherein the size of the central graphical element is substantially one-third of the width of the generated graphical user interface.

8. The computer-implemented method of claim 1, wherein the central graphical element is horizontally positioned substantially in the middle if the generated graphical user interface.

9. The computer-implemented method of claim 1, wherein the content block is positioned substantially below the central graphical element.

10. The computer-implemented method of claim 1, wherein the determined length of the user gesture is either a full display width or half display width.

11. A non-transitory computer-readable medium embodying a set of computer-readable instructions, which, when executed in connection with a computerized system comprising a processor, a memory and a display device, cause the computerized system to perform a method for automated generation of a graphical user interface for a target application, the method comprising:
a. obtaining a content associated with the target application;
b. using the obtained content to generate a central graphical element, the central graphical element being generated using at least a first potion of the obtained content;
c. magnifying at least a second portion of the content;
d. applying a Gaussian blurring filter to the magnified second portion of the content;
e. generating a background image based on the blurred magnified second portion of the content; and
f. generating the graphical user interface, the graphical user interface comprising the central graphical element, the background image and a content block, wherein the central graphical element and the content block overlay the background image.

12. The non-transitory computer-readable medium of claim 11, wherein the content block comprises at least one interactive graphical user interface control element.

13. The non-transitory computer-readable medium of claim 11, wherein the content block comprises textual content descriptive of the target application.

14. The non-transitory computer-readable medium of claim 11, wherein the target application is a software application.

15. The non-transitory computer-readable medium of claim 11, wherein the target application is a user profile.

16. The non-transitory computer-readable medium of claim 11, wherein the central graphical element has a square shape.

17. The non-transitory computer-readable medium of claim 16, wherein the size of the central graphical element is substantially one-third of the width of the generated graphical user interface.

18. The non-transitory computer-readable medium of claim 11, wherein the central graphical element is horizontally positioned substantially in the middle if the generated graphical user interface.

19. The non-transitory computer-readable medium of claim 11, wherein the content block is positioned substantially below the central graphical element.

20. A computerized system comprising a processor, a memory and a display device, the memory storing a set of computer-readable instructions, which, when executed by the processor cause the computerized system to perform a method for automated generation of a graphical user interface for a target application, the method comprising:
a. obtaining a content associated with the target application;
b. using the obtained content to generate a central graphical element, the central graphical element being generated using at least a first potion of the obtained content;
c. magnifying at least a second portion of the content;
d. applying a Gaussian blurring filter to the magnified second portion of the content;
e. generating a background image based on the blurred magnified second portion of the content; and
f. generating the graphical user interface, the graphical user interface comprising the central graphical element, the background image and a content block, wherein the central graphical element and the content block overlay the background image.
